(19) United States
(12) Patent Application Publication
(10) Pub. No.: US 2019/0130360 A1
(43) Pub. Date: May 2, 2019

(54) MODEL-BASED RECOMMENDATION OF CAREER SERVICES

(71) Applicant: Microsoft Technology Licensing, LLC, Redmond, WA (US)

(72) Inventors: Ke Wu, Sunnyvale, CA (US); Yi Zhang, Sunnyvale, CA (US); Hong Yao, Fremont, CA (US); Onkar A. Dalal, Santa Clara, CA (US); Yu Liu, Sunnyvale, CA (US)

(73) Assignee: Microsoft Technology Licensing, LLC, Redmond, WA (US)

(21) Appl. No.: 15/799,490

(22) Filed: Oct. 31, 2017

(51) Int. Cl. G06Q 10/10; G06Q 50/00; G06Q 10/06

(52) U.S. Cl. CPC G06Q 10/1053; G06N 7/005; G06Q 10/067; G06Q 50/01

(57) ABSTRACT

During operation, a system obtains member features associated with a member of a network, wherein the set of member features include a job-seeking status of the member. Next, the system analyzes the member features to predict an interest of the member in career services associated. The system then uses the predicted interest to output a recommendation of the career services to the member.

### BACKGROUND

### Field

The disclosed embodiments relate to user recommendations. More specifically, the disclosed embodiments relate to techniques for performing model-based recommendation of career services.

### Related Art

Online networks may include nodes representing individuals and/or organizations, along with links between pairs of nodes that represent different types and/or levels of social familiarity between the nodes. For example, two nodes in an online network may be connected as friends, acquaintances, family members, classmates, and/or professional contacts. Online networks may further be tracked and/or maintained on web-based networking services, such as online professional networks that allow the individuals and/or organizations to establish and maintain professional connections, list work and community experience, endorse and/or recommend one another, run advertising and marketing campaigns, promote products and/or services, and/or search and apply for jobs.

In turn, online professional networks may facilitate activities related to business, sales, recruiting, networking, professional growth, and/or career development. For example, professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for improving use of a social network in accordance with the disclosed embodiments.

FIG. 3 shows a flowchart illustrating a process of recommending career services to a member in accordance with the disclosed embodiments.

FIG. 4 shows a flowchart illustrating a process of predicting an interest of a member in career services in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

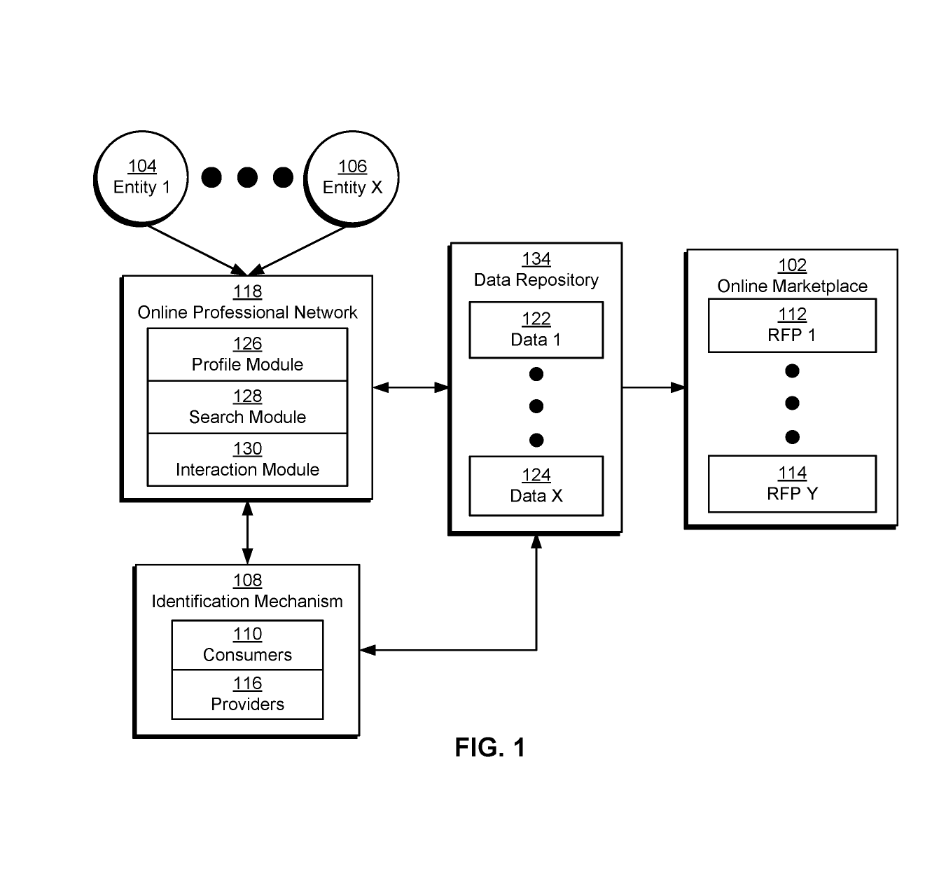

The disclosed embodiments provide a method, apparatus, and system for improving use of a social network or another community of users. As shown in FIG. 1, the social network may include an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In turn, member profiles and/or activity with online professional network 118 may be used by an online marketplace 102 associated with and/or provided by online professional network 118 to improve interaction between consumers 110 and providers 116 and/or use of online marketplace 102 by consumers 110 and providers 116. Online marketplace 102 may allow consumers 110 to generate requests for proposal (RFPs) (e.g., RFP 1 112, RFP y 114) for products or services by inputting requirements associated with the RFPs into a user interface, form, email, and/or other mechanism for digital communication or interaction. Online marketplace 102 may use the inputted requirements to select providers 116 that meet the requirements and transmit the RFPs to the selected providers 116. The selected providers 116 may respond to the RFPs with proposals, and consumers 110 from which the RFPs were received may use the proposals to select providers 116 for the corresponding products or services.

As shown in FIG. 1, consumers 110 and/or providers 116 may be identified by an identification mechanism 108 using data from data repository 134 and/or online professional network 118. First, identification mechanism 108 may identify consumers 110 based on browsing, searching, and/or viewing activities of entities with online professional network 118. For example, identification mechanism 108 may determine that a member of online professional network 118 is interested in career services offered through online marketplace 102 based on the member's job-seeking activity (e.g., job searches, job applications, etc.) and/or profile-editing activity (e.g., profile edits, soliciting recommendations or endorsements, etc.) with online professional network 118. In another example, identification mechanism 108 may identify a member of online professional network 108 as a potential consumer when the member searches online marketplace 102 for products and/or services and/or submits an RFP through online marketplace 102.

Second, identification mechanism 108 may identify providers 116 as members of online professional network 118 who are highly skilled at services offered through online marketplace 102 and/or who have registered with online marketplace 102 as providers 116 of the services. For example, identification mechanism 108 may use endorsements, recommendations, and/or other social validation of skills listed in the member's profiles with online professional network 118 to identify members who are likely to be highly capable of providing services listed in online marketplace 102. In another example, identification mechanism 108 may identify a member of online professional network 118 as a provider in online marketplace 102 when the member views a page in online marketplace 102 for a service that strongly matches the member's skills and/or registers as a provider with online marketplace 102.

In one or more embodiments, online professional network 118 data is used to increase usage of online marketplace 102 by consumers 110 and/or providers 116. As described in further detail below, profile and/or activity data with online professional network 118 may be used to identify members who are job seekers and/or interested in career services offered through online marketplace 102. In turn, online professional network 118 may output recommendations of the career services to members who are identified as having significant interest in the career services, thereby increasing interaction between consumers 110 and providers 116 through online marketplace 102 and/or use of online professional network 118 and online marketplace 102 by consumers 110 and/or providers 118.

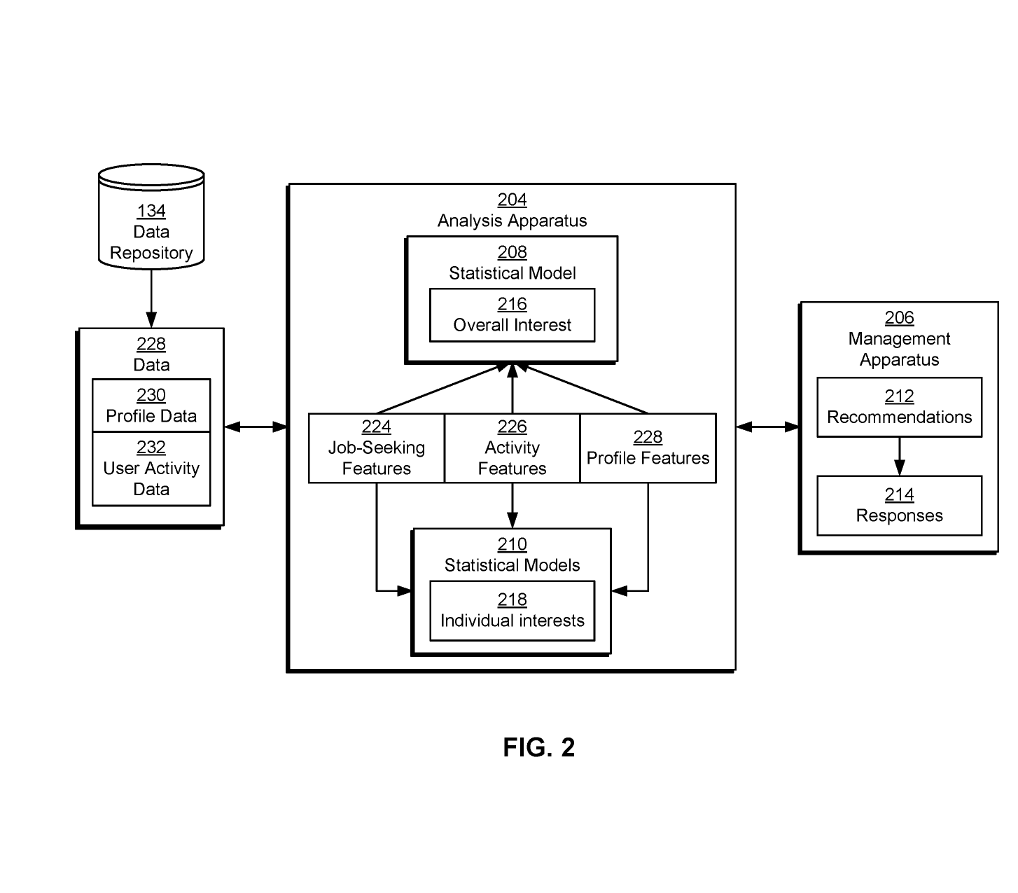

FIG. 2 shows a system for processing data in accordance with the disclosed embodiments. More specifically, FIG. 2 shows a system for recommending career services to a member of a social network, such as online professional network 118 of FIG. 1.

As shown in FIG. 2, the system utilizes data 228 from data repository 134, which includes profile data 230 for members of a social network (e.g., online professional network 118 of FIG. 1), as well as user activity data 232 that tracks the members' activity within and/or outside the social network. Profile data 230 may include data associated with member profiles in the social network. For example, profile data 230 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs), and/or educational (e.g., degree, university attended, courses, fellowships, etc.) attributes. Profile data 230 may also include a set of groups to which the user belongs, the user's contacts and/or connections, patents or publications associated with the user, and/or other data related to the user's interaction with the social network.

Attributes of the members may be matched to a number of member segments, with each member segment containing a group of members that share one or more common attributes. For example, member segments in the social network may be defined to include members with the same industry, title, location, and/or language.

Connection information in profile data 230 may additionally be combined into a graph, with nodes in the graph representing entities (e.g., users, schools, companies, locations, etc.) in the social network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 232 may include records of member interactions with one another and/or content associated with the social network. For example, user activity data 232 may be used to track impressions, clicks, likes, dislikes, shares, hides, comments, posts, updates, conversions, and/or other user interaction with content in the social network. User activity data 232 may also track other types of social network activity, including connections, messages, job searches, job applications, recruiter interactions, and/or interaction with groups or events. User activity data 232 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes.

User activity data 232 may additionally track activities related to an online marketplace, such as online marketplace 102 of FIG. 1. The activities may include, but are not limited to, browsing or searching the online marketplace for providers, services, products, and/or projects; submitting, receiving, responding to, and/or accepting RFPs and proposals; viewing profiles of providers in the online marketplace; exchanging messages with providers and/or consumers; sending and/or receiving connection invitations with providers and/or consumers; and/or rating or reviewing providers and/or consumers. Like profile data 230, user activity data 232 may be used to create a graph, with nodes in the graph representing social network members and/or content and edges between pairs of nodes indicating actions taken by members, such as creating or sharing articles or posts, sending messages, sending or accepting connection requests, sending and accepting RFPs, sending and accepting proposals, joining groups, and/or following other entities.

Profile data 230, user activity data 232, and/or other data in data repository 134 may be standardized before the data is used by components of the system. For example, skills in profile data 230 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

An analysis apparatus 204 uses profile data 230, user activity data 232, and/or other data 228 in data repository 134 to predict a member's interest in career services offered by or through the social network and/or online marketplace. More specifically, analysis apparatus 204 may use a set of job-seeking features 224, activity features 226, and/or member features 228 as input to one or more statistical models 208-210. In turn, statistical models 208-210 may output scores representing the member's overall interest 216 in career services and/or individual interests 218 in different career service types for the career services.

Job-seeking features 224 may represent the member's job-seeking behavior, within or outside the social network. For example, job-seeking features 224 may include views, searches, applications, and/or other activity of the member with job postings in the social network; interactions with recruiters; and/or views or searches of company-specific pages in the social network. Job-seeking features 224 may also, or instead, include a “job seeker score” that classifies the member's job-seeking status as a job seeker or non-job-seeker and/or estimates the member's level of job-seeking interest.

Activity features 226 may describe the member's type or level of activity with the social network. For example, the activity features may include an activity level of the member with the social network, which may be binary (e.g., dormant or active) or calculated by aggregating different types of activities into an overall activity count and/or a bucketized activity score. In another example, the activity features may include attributes (e.g., activity frequency, dormancy, etc.) related to specific types of social network activity, such as page views, profile views, company views, invitations, content feed interactions (e.g., likes, posts, comments, shares, clicks, etc.), messaging activity (e.g., sending messages within the social network), publishing activity (e.g., publishing posts or articles in the social network), mobile activity (e.g., accessing the social network through a mobile device), and/or email activity (e.g., accessing the social network through email or email notifications). In a third example, the activity features may include queries and/or search results associated with the member's searches within the social network.

Activity features 226 may also characterize the member's activity with the online marketplace. For example, the activity features may include interactions with providers in the online marketplace, such as messages, invitations, profile views, and/or recommendations received from the providers and/or transmitted to the providers. In another example, the activity features may include attributes related to browsing and/or searching of the online marketplace for providers, services, products, and/or projects; submitting, receiving, responding to, and/or accepting RFPs and proposals; and/or rating or reviewing providers and/or consumers.

Profile features 228 may include profile attributes from the member's profile with the social network. For example, profile features 228 may include semantic and/or numeric attributes related to the member's title, industry, language, summary, occupation, work experience (e.g., number of current and/or past positions, length of employment, etc.), educational background (e.g., number of schools, length of education, degrees, etc.), skills, seniority, employer, employer size, employer industry, groups, contact information, profile visibility, profile completeness, connections, and/or number of connections.

After job-seeking features 224, activity features 226, and/or profile features 228 are obtained from data repository 134, analysis apparatus 204 and/or another component of the system may modify some or all of the features. First, the component may apply imputations that add default values, such as zero numeric values or median values, to features with missing values. Second, the component may “bucketize” numeric values for some features (e.g., number of employees, growth rate, etc.) into ranges of values and/or a smaller set of possible values. Third, the component may apply, to one or more subsets of features, a log transformation that reduces skew in numeric values and/or a binary transformation that converts zero and positive numeric values to respective Boolean values of zero and one. Fourth, the component may normalize scores to be within a range (e.g., between 0 and 10), verify that feature ratios are within the range of 0 and 1, and perform other transformations of the features. In general, such preprocessing and/or modification of features may be performed and/or adapted based on configuration files and/or a central feature list.

Next, analysis apparatus 204 uses statistical model 208 to predict the member's overall interest 216 in career services offered by or through the social network and/or online marketplace. For example, analysis apparatus 204 may obtain, from statistical model 208, a score representing the member's propensity and/or likelihood in requesting career services when presented with one or more recommendations 212 related to the career services.

Analysis apparatus 204 may also, or instead, use statistical models 210 to characterize the member's individual career-related interests 218 in different types of career services, such as resume writing, career coaching, executive coaching, interview coaching, life coaching, public speaking, and/or leadership development. In turn, statistical models 210 may output scores that represent the member's propensities in requesting the corresponding types of career services when presented with recommendations 212 related to the career service types.

Statistical models 208-210 may be trained using a positive class of members that have recently visited the online marketplace, interacted with providers in the online marketplace, browsed or searched services (e.g., career services, specific career service types, etc.) and/or providers in the online marketplace, and/or viewed or created RFPs for the corresponding services in the online marketplace. The positive class may also, or instead, include members that have navigated to the online marketplace from search results and/or emails or pages promoting the online marketplace and/or specific services offered through the online marketplace. The positive class may optionally be restricted to members who are identified as job seekers in the social network. A negative class for training the statistical models may include members that did not click on emails, search results, and/or pages promoting services offered through the online marketplace (e.g., career services, specific career service types, etc.). The negative class may also, or instead, include members who are not identified as job seekers in the social network.

The positive class and negative class may be labeled with different values (e.g., 1 for the positive class and 0 for the negative class), and the labels may be provided with features of the corresponding members as training data to statistical models 208-210 such as logistic regression models, gradient-boosted trees, and/or other types of classification models. For example, statistical model 208 may be trained to reflect overall interest 216 in career services offered through the social network and/online or marketplace, and each of statistical models 210 may be trained to predict individual interest in a specific type of career service offered through the social network and/or online marketplace. Statistical model 208 may thus be trained using member features for members that have outcomes related to accessing career services through the social network and/or online marketplace, and statistical models 210 may each be trained using member features for members that have outcomes related to accessing the corresponding types of career services through the social network and/or online marketplace.

After statistical models 208-210 are trained, analysis apparatus 204 uses statistical models 208-210 to predict overall interest 216 in career services and/or individual interests 218 in different types of career service for additional members of the social network that are not in the original set of training data. For example, analysis apparatus 204 may combine a score representing overall interest 216 with a set of scores representing individual interests 218 into a set of combined scores representing a member's predicted response to recommendations 212 of the corresponding career service types. Each pair of scores may be combined by summing the scores, multiplying the scores, applying a set of weights to the scores, and/or otherwise aggregating the scores. The same threshold and/or different thresholds may then be applied to the combined scores to identify the member as interested or uninterested in the corresponding career service types.

In turn, a management apparatus 206 generates recommendations 212 based on the output of analysis apparatus 204. For example, management apparatus 206 may recommend career services and/or one or more types of career services to the member when the corresponding combined scores exceed a threshold. Recommendations 212 may be included in emails, messages, and/or other communications from or within the social network; a content feed, job listing page, job search page, company page, and/or other part of the social network; and/or advertisements within or outside the social network.

Management apparatus 206 also tracks responses 214 of the member to recommendations 212. For example, management apparatus 206 may categorize clicks, RFPs, and/or other subsequent actions that follow through on recommendations 212 as positive responses and a lack of subsequent action as negative responses. Each response may be stored in data repository 134 with an identifier of the corresponding member, an identifier of the recommendation to which the response was made, a timestamp of the response, and/or other data.

In turn, analysis apparatus 204 and/or another component of the system may use the response to update statistical models 208-210, features used by statistical models 208-210, and/or other components used to recommend career services to members of the social network. For example, the component may use the member's positive response to a recommendation for resume writing services to follow up with a recommendation for interview coaching at a later point in the member's job-seeking process. In another example, the component may use the member's negative response to a recommendation as additional training data for the corresponding statistical model(s).

By assessing overall interest 216 in career services and/or individual interests 218 for different career service types using job-seeking features 224, activity features 226, and profile features 228, the system of FIG. 2 may direct and/or target recommendations 212 of the career services and/or career service types in a way that increases the relevance of recommendations 212 to members of the social network and/or the use of career services offered by providers in the online marketplace. In turn, the system may increase the value of the social network and/or online marketplace to the members, the value provided by the members to the social network and/or online marketplace, and/or member engagement with the social network and/or online marketplace. Consequently, the system may improve technologies related to use of social networks and/or online marketplaces through network-enabled devices and/or applications, as well as user engagement, user experiences, and interaction through the social networks, online marketplaces, network-enabled devices, and/or applications.

Those skilled in the art will appreciate that the system of FIG. 2 may be implemented in a variety of ways. First, analysis apparatus 204, management apparatus 206, and/or data repository 134 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, a number of statistical models 208-210 and/or techniques may be used to determine overall interest 216 and/or individual interests 218. For example, the functionality of each statistical model may be provided by a regression model, artificial neural network, support vector machine, decision tree, random forest, gradient boosting tree, naïve Bayes classifier, Bayesian network, clustering technique, deep learning model, hierarchical model, and/or ensemble model.

Moreover, the same statistical model or separate statistical models may be used to generate scores for various members, member segments, career services, and/or career service types. For example, one statistical model (e.g., a multi-class classification model) may be used to predict a career service type in which the member is interested and/or identify the member's lack of interest in all career service types. In another example, a first stage in a two-staged model may be used to predict the member's overall interest 216 in career services. When the member is classified as generally interested in career services, a multi-class classification model in the second stage of the two-stage model may subsequently be used to determine the member's interest in one or more career service types. In a third example, a score representing the member's overall interest 216 from statistical model 208 may be combined with scores representing individual interests 218 from statistical models 210 to obtain a set of combined scores representing the member's interest in one or more career service types, as described above.

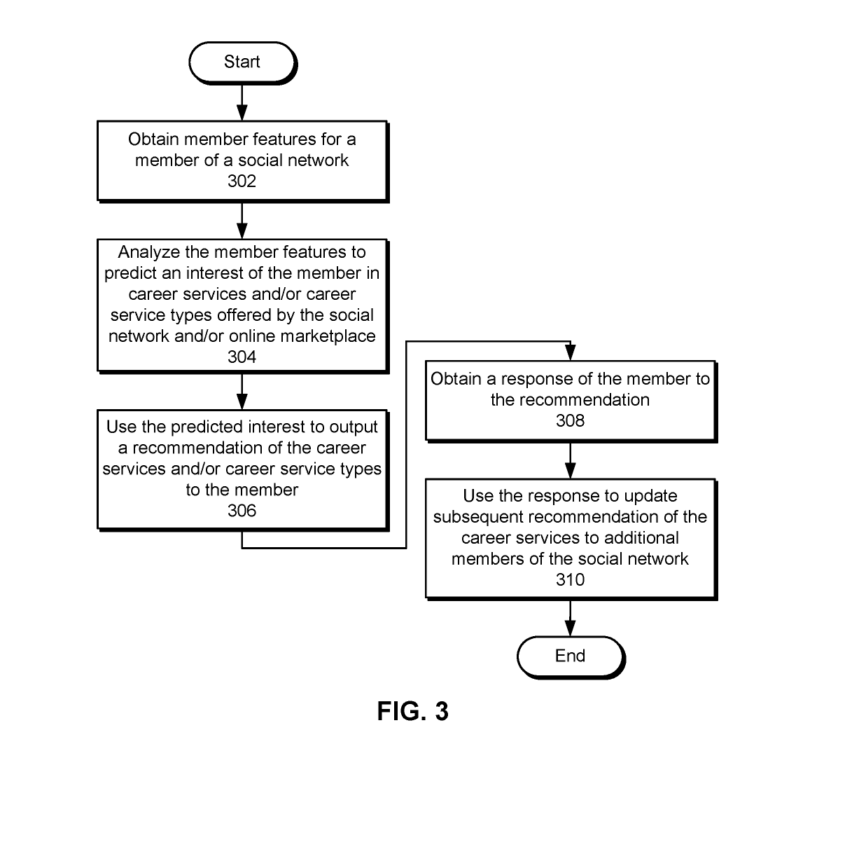

FIG. 3 shows a flowchart illustrating a process of recommending career services to a member of a social network in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, member features for a member of a social network are obtained (operation 302). The member features may include job-seeking features associated with the member's job-seeking behavior and/or a job seeker score that identifies the member's job-seeking status (e.g., job seeker, non-job-seeker, level of interest in job-seeking, etc.). The member features may also include an activity feature representing the member's activity with the social network and/or an online marketplace associated with the social network. The member features may further include a profile feature associated with the member's profile in the social network.

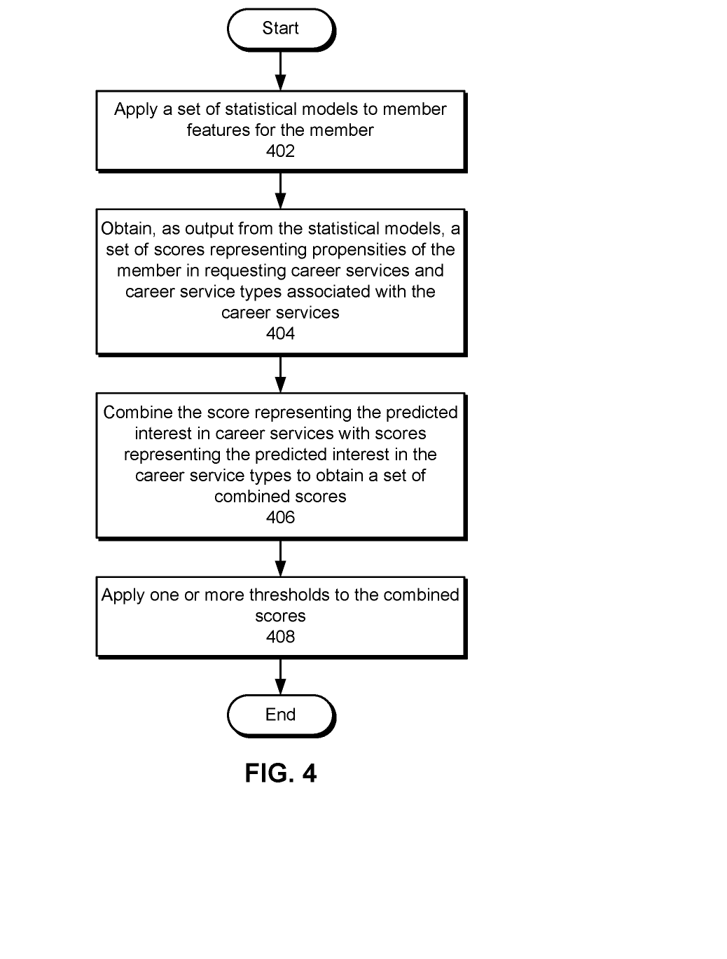

Next, the member features are analyzed to predict an interest of the member in career services and/or career service types offered by the social network and/or an online marketplace (operation 304), as described in further detail below with respect to FIG. 4. The predicted interest is then used to output a recommendation of the career services and/or career service types to the member (operation 306). For example, the recommendation may be outputted when one or more scores representing the predicted interest exceed a threshold. The recommendation may be displayed when the member accesses the social network, in an email to the member, and/or in another form of communication with the member. The recommendation may include one or more career service types associated with the above-threshold scores and/or other indications of high predicted interest from the member, one or more providers of the recommended career services, descriptions of the recommended career services, a link to an RFP for the recommended career services, and/or other information to assist the user with requesting and/or using the career services through the social network and/or online marketplace.

A response of the member to the recommendation is obtained (operation 308) and used to update subsequent recommendation of the career services to additional members of the social network (operation 310). For example, the acceptance, rejection, and/or lack of response to a recommended career service and/or career service type may be included in member features for the member. The updated features may subsequently be used to update statistical models and/or scores for predicting interests in career services and/or career service types and/or the outputting of recommendations based on the scores. Thus, recommendations of career services for the member and/or other members may evolve or improve over time.

FIG. 4 shows a flowchart illustrating a process of predicting an interest of a member in career services associated with a social network in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a set of statistical models is applied to member features for the member (operation 402). The statistical models may include a first statistical model that evaluates and/or predicts the member's overall interest in career services offered by or within the social network. The statistical models may also include a set of additional statistical models that evaluate and/or predict the member's individual interest in various career service types associated with the career services. For example, the additional statistical models may include separate models for assessing the member's interest in resume writing, interview coaching, career coaching, executive coaching, life coaching, public speaking, and/or leadership development.

Next, a set of scores representing propensities of the member in requesting the career services and career service types is obtained as output from the statistical models (operation 404). For example, the scores may include an overall score that represents the member's likelihood of clicking on recommendations of the career services and/or a set of individual scores representing the member's likelihood of clicking on recommendations of individual career service types. In another example, the scores may represent the member's propensities to create RFPs for the career services and/or corresponding career service types through an online marketplace associated with the social network.

The score representing the member's predicted interest in career services is then combined with scores representing the member's predicted interest in the career service types to obtain a set of combined scores (operation 406). For example, the score representing the member's overall interest in career services may be added to, multiplied by, and/or otherwise aggregated with each score representing the member's interest in an individual career service type to obtain a combined score for the career service type.

Finally, one or more thresholds are applied to the combined scores (operation 408) to determine if the member is interested in any types of career services. For example, a threshold for each combined score may be set to achieve a certain precision and/or recall. In turn, a value of the combined score that exceeds the threshold may indicate that the member is interested in (e.g., likely to click or follow up on) a recommendation of a corresponding career service type. Conversely, a value of the combined score that falls below the threshold may indicate that the member is not interested in (e.g., not likely to click or follow up on) a recommendation of the corresponding career service type.

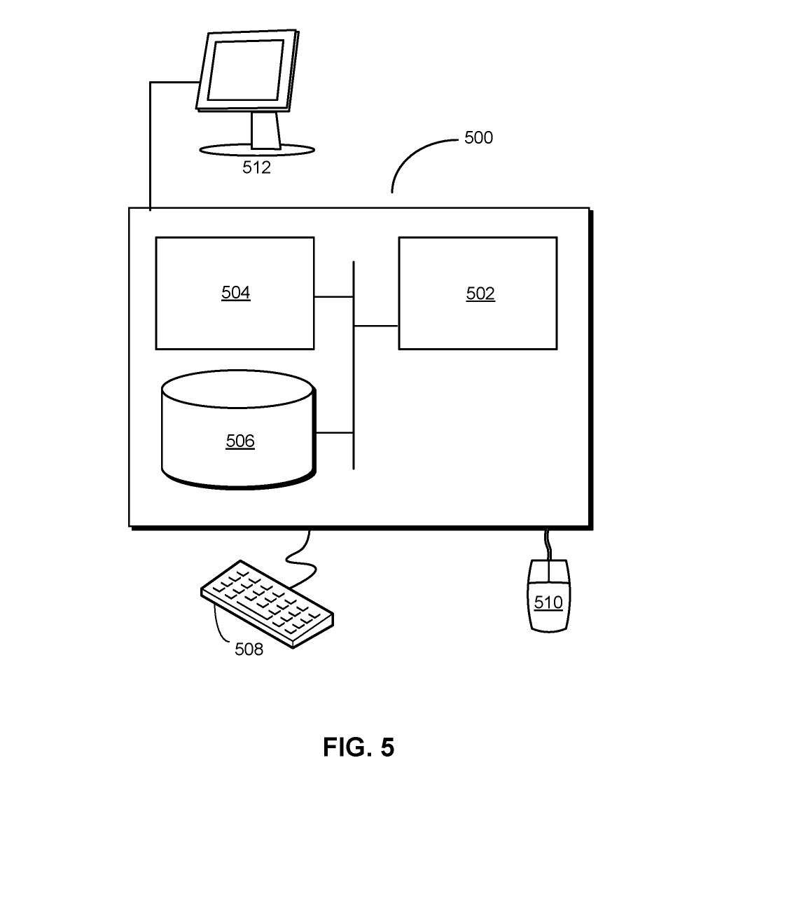

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for improving use of a social network. The system includes an analysis apparatus and a management apparatus, one or both of which may alternatively be termed or implemented as a module, mechanism, or other type of system component. The analysis apparatus may obtain member features associated with a member of a social network. The member features may include a job-seeking status, activity feature, and/or profile feature for the member. Next, the analysis apparatus may analyze the member features to predict an interest of the member in career services associated with the social network and/or additional interests of the member in a number of career service types associated with the career services. The management apparatus then uses the predicted interest(s) to output a recommendation of the career services to the member.

In addition, one or more components of computer system 500 may be remotely located and connected to the other components over a network. Portions of the present embodiments (e.g., analysis apparatus, management apparatus, data repository, attribute repository, etc.) may also be located on different nodes of a distributed system that implements the embodiments. For example, the present embodiments may be implemented using a cloud computing system that recommends career services to a set of remote members of a social network.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining member features associated with a member of a social network;
applying, by one or more computer systems, a set of statistical models to the member features to obtain an overall score representing a propensity of the member in requesting career services and a set of scores representing the propensity of the member in requesting a set of career service types;
combining the overall score with the set of scores to obtain a set of combined scores for the member; and
outputting, based on a threshold for the set of combined scores, a recommendation of the career services to the member.

2. The method of claim 1, wherein outputting, based on the threshold for the set of combined scores, a recommendation of the career services to the member comprises:
outputting the recommendation of a career service type in the set of career service types when a combined score associated with the career service type exceeds the threshold.

3. A method, comprising:
obtaining member features associated with a member of a social network, wherein the set of member features comprises a job-seeking status of the member;
analyzing, by one or more computer systems, the member features to predict an interest of the member in career services associated with the social network; and
using the predicted interest to output a recommendation of the career services to the member.

4. The method of claim 3, further comprising:
analyzing the member features to predict additional interests of the member in a set of career service types associated with the career services; and
using the predicted additional interests to modify the recommendation.

5. The method of claim 4, wherein analyzing the member features to predict the additional interests of the member in the set of career service types associated with the career services comprises:
applying a set of statistical models to the member features;
obtaining, as output from the set of statistical models, a set of scores representing propensities of the member in requesting the set of career service types; and
combining the set of scores with a score representing the predicted interest of the member in the career services to obtain a set of combined scores representing the additional interests of the member in the set of career service types.

6. The method of claim 4, wherein using the predicted additional interests to modify the recommendation comprises:
including, in the recommendation, a career service type associated with a high predicted interest for the member.

7. The method of claim 4, wherein the set of career service types comprises at least one of:
resume writing;
career coaching;
executive coaching;
interview coaching;
life coaching;
public speaking; and
leadership development.

8. The method of claim 3, wherein analyzing the member features to predict the interest of the member in the career services associated with the social network comprises:
applying a statistical model to the member features;
obtaining, as output from the statistical model, a score representing a propensity of the member in requesting the career services.

9. The method of claim 8, wherein using the predicted interest to output the recommendation of the career services to the member comprises:
outputting the recommendation when the score exceeds a threshold.

10. The method of claim 3, further comprising:
obtaining a response of the member to the recommendation; and
using the response to update subsequent recommendation of the career services to additional members of the social network.

11. The method of claim 3, wherein the member features further comprise:
an activity feature representing activity of the member with the social network.

12. The method of claim 3, wherein the member features further comprise:
an activity feature representing activity of the member with an online marketplace associated with the social network.

13. The method of claim 3, wherein the member features further comprise:
a profile feature associated with a member profile of the member in the social network.

14. The method of claim 3, wherein using the predicted interest to output the recommendation of the career services to the member comprises:
including one or more providers of the career services in the recommendation.

15. A non-transitory computer-readable storage medium storing instructions that when executed by a computer cause the computer to perform a method, the method comprising:
obtaining member features associated with a member of a social network, wherein the set of member features comprises a job-seeking status of the member;
analyzing the member features to predict an interest of the member in career services associated with the social network; and
using the predicted interest to output a recommendation of the career services to the member.

16. The non-transitory computer-readable storage medium of claim 15, wherein the method further comprises:
analyzing the member features to predict additional interests of the member in a set of career service types associated with the career services; and
using the predicted additional interests to modify the recommendation.

17. The non-transitory computer-readable storage medium of claim 16, wherein analyzing the member features to predict the additional interests of the member in the set of career service types associated with the career services comprises:
applying a set of statistical models to the member features;
obtaining, as output from the set of statistical models, a set of scores representing propensities of the member in requesting the set of career service types; and
combining the set of scores with a score representing the predicted interest of the member in the career services to obtain a set of combined scores representing the additional interests of the member in the set of career service types.

18. The non-transitory computer-readable storage medium of claim 15, wherein analyzing the member features to predict the interest of the member in the career services associated with the social network comprises:
applying a statistical model to the member features;
obtaining, as output from the statistical model, a score representing a propensity of the member in requesting the career services.

19. The non-transitory computer-readable storage medium of claim 18, wherein using the predicted interest to output the recommendation of the career services to the member comprises:
outputting the recommendation when the score exceeds a threshold.

20. The non-transitory computer-readable storage medium of claim 15, wherein the member features further comprise:
a first activity feature representing activity of the member with the social network;
a second activity feature representing activity of the member with an online marketplace associated with the social network; and
a profile feature associated with a member profile of the member in the social network.
